(19) United States
(12) Patent Application Publication
(10) Pub. No.: US 2020/0303091 A1
(43) Pub. Date: Sep. 24, 2020

(54) DATA COMMUNICATION CABLE ASSEMBLY INCLUDING FIRE RETARDANT MATERIAL

(71) Applicant: Cosemi Technologies, Inc., Irvine, CA (US)

(72) Inventors: Devang Parekh, Castro Valley, CA (US); Samir V. Desai, Rancho Santa Margarita, CA (US); Atul Sharma, Frisco, TX (US)

(21) Appl. No.: 16/356,395

(22) Filed: Mar. 18, 2019

(51) Int. Cl. H01B 7/295; H01B 3/44; H01R 9/05; H01B 11/22; H01B 11/18

(52) U.S. Cl. CPC H01B 7/295; H01B 3/445; H01B 11/1895; H01B 11/22; H01R 9/05

(57) ABSTRACT

A fire-retardant data communication cable assembly including an outer coaxial jacket made out of fire-retardant material (e.g., Flourinated Ethylene Propylene (FEP)) coaxially enclosing optical and wire communication mediums, metal (e.g., copper) braid, metal (e.g., aluminum) foil, drain wire, and aramid fibers for substantially the entire length of the cable; a tube made out of fire-retardant material (e.g., Ethylene Tetrafluoroethylene (ETFE) or polyolefin) coaxially enclosing one or more optical communication mediums (e.g., optical fibers) and one or more aramid fibers for substantially the entire length of the cable; a fire-retardant coating (e.g., FEP) coaxially disposed over each of the one or more wire mediums for substantially the entire length of the cable.

### BACKGROUND

### Field

Aspects of the present disclosure relate generally to data communication cables, and in particular, to a data communications cable assembly including fire retardant material.

### Background

Many applications require cabling to go through regulated environments, such as plenum space, that require certification for fire retardance. Fire retardant materials are necessary for cabling to meet regulatory standards in the United States (US), Canada, European Union (EU), Australia, New Zealand, and other markets. By fire retardance, the cable should be rated to meet or exceed any or all of the following tests: flame spread, total heat release, peak heat release rate, smoke production, flaming droplets, and acidity. In the US, these are governed by the National Fire Protection Association (NFPA); in the EU, it is governed by the Construction Product Regulations (CPR), and worldwide by the International Electrotechnical Commission (IEC).

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

An aspect of the disclosure relates to a data communication cable assembly including a cable including a set of one or more communication mediums for transmitting one or more data signals, one or more control signals, and/or one or more power signals; a first connector, attached to a first end of the cable, configured to mate with a corresponding connector of a first device, wherein the first connector includes a first set of electrical contacts configured to send and/or receive the one or more data signals, the one or more control signals, and/or the one or more power signals to and/or from the first device; a second connector, attached to a second end of the cable, configured to mate with a corresponding connector of a second device, wherein the second connector includes a second set of electrical contacts configured to send and/or receive the one or more data signals, one or more control signals, and/or the one or more power signals to and/or from the second device; and a jacket made out of a fire-retardant material coaxially enclosing the one or more communication mediums for substantially an entire length of the cable.

Another aspect of the disclosure relates to a data communication cable assembly including a cable including one or more optical communication mediums for transmitting a first set of one or more data signals; and one or more wire communication mediums for transmitting one or more control signals and/or one or more power signals; a first connector, attached to a first end of the cable, configured to mate with a corresponding connector of a first device, wherein the first connector includes a first set of electrical contacts configured to send and/or receive the one or more data signals, the one or more control signals, and/or the one or more power signals to and/or from the first device; a second connector, attached to a second end of the cable, configured to mate with a corresponding connector of a second device, wherein the second connector includes a second set of electrical contacts configured to send and/or receive the one or more data signals, one or more control signals, and/or the one or more power signals to and/or from the second device; and a jacket made out of a fire-retardant material coaxially enclosing the first and second sets of one or more communication mediums for substantially an entire length of the cable.

Another aspect of the disclosure includes a data communication cable assembly including a cable with one or more optical communication mediums for transmitting one or more data signals; one or more wire communication mediums for transmitting one or more control signals and/or one or more power signals, wherein each of the one or more wire communication mediums is coated with a fire-retardant material for substantially the entire length of the cable; a jacket made out of a fire-retardant material coaxially enclosing the optical and wire communication mediums for substantially an entire length of the cable; and a tube made out of fire-retardant material coaxially enclosing the one or more optical communication mediums for substantially the entire length of the cable, wherein the jacket coaxially encloses the tube for substantially the entire length of the cable.

The data communication cable assembly further includes a first connector, attached to a first end of the cable, configured to mate with a corresponding connector of a first device, wherein the first connector includes a first set of electrical contacts configured to send and/or receive the one or more data signals, the one or more control signals, and/or the one or more power signals to and/or from the first device; and a second connector, attached to a second end of the cable, configured to mate with a corresponding connector of a second device, wherein the second connector includes a second set of electrical contacts configured to send and/or receive the one or more data signals, the one or more control signals, and/or the one or more power signals to and/or from the second device.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the description embodiments are intended to include all such aspects and their equivalents.

### BRIEF DESCRIPTION OF THE DRAWINGS

FIG. 1A illustrates a block/schematic diagram of an exemplary data communication cable assembly in accordance with an aspect of the disclosure.

FIG. 1B illustrate a cross-sectional view of the exemplary data communication cable assembly of FIG. 1A in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

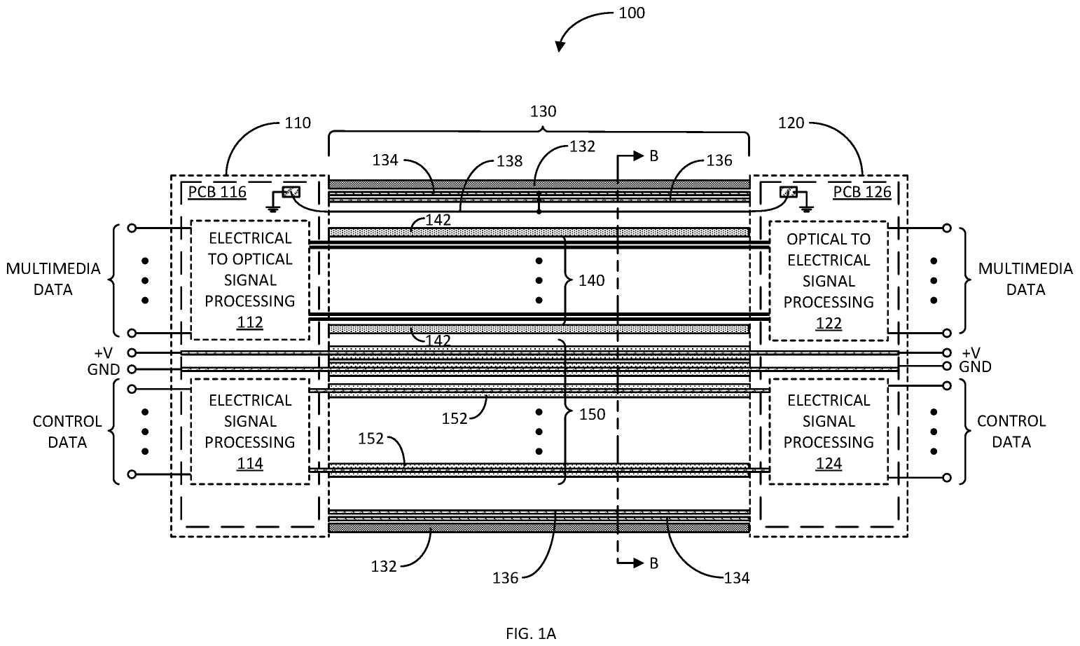

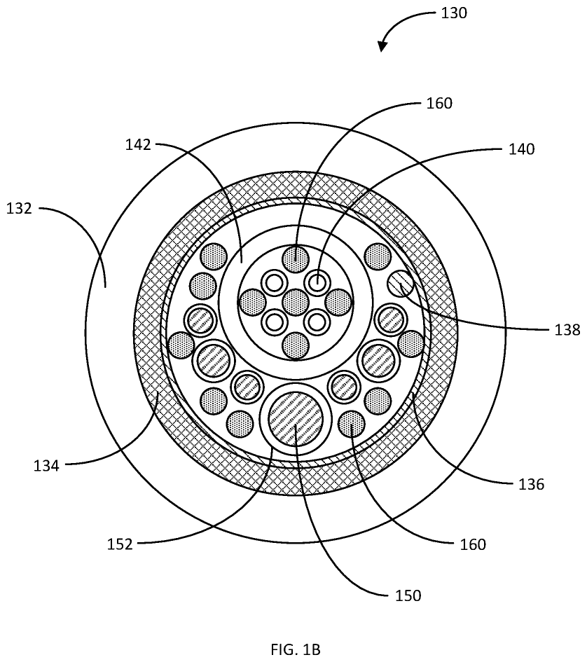

FIG. 1 illustrates a block/schematic diagram of an exemplary data communication cable assembly 100 in accordance with an aspect of the disclosure. In summary, the data communication cable assembly 100 includes features to make the cable assembly fire retardant, and meet the standard provided by the NFPA, CPR, and the IEC. This allows a single cable design to be used in regulated environments in the US, EU, and other parts of the world, and comply with their fire-retardant standards. The data communication cable assembly 100 may also be environmentally-safe by not including polyvinyl chloride (PVC), phthalate-free, RoHS compliant, and REACH compliant.

The data communication cable assembly features include: (1) an outer coaxial jacket made out of fire-retardant material (e.g., Flourinated Ethylene Propylene (FEP)) coaxially enclosing the optical and wire communication mediums, metal (e.g., copper) braid, metal (e.g., aluminum) foil, drain wire, and aramid fibers for substantially the entire length of the cable; (2) a tube made out of fire-retardant material (e.g., Ethylene Tetrafluoroethylene (ETFE) or polyolefin) coaxially enclosing one or more optical communication mediums (e.g., optical fiber) and one or more aramid fibers for substantially the entire length of the cable; and (3) a fire-retardant coating (e.g., FEP) coaxially disposed over each of the one or more wire mediums for substantially the entire length of the cable.

In particular, the data communication cable assembly 100 includes a first connector 110, a second connector 120, and a cable 130 including opposite ends attached to the first and second connectors 110 and 120, respectively. The first connector 110 is configured to mate with a corresponding connector of a first device (not shown). The second connector 120 is configured to mate with a corresponding connector of a second device (not shown). The cable 130 includes communication mediums for transmitting data signals, control signals, and/or power signals between the first and second devices.

The first connector 110 includes electrical contacts (e.g., pins and/or sockets) for electrically mating with corresponding electrical contacts (e.g., sockets and/or pins) of the first device. Some of the electrical contacts may be for providing and/or receiving multimedia data (e.g., video and/or audio data) signals to and/or from the first device. Other electrical contacts may be for providing and/or receiving power signals (e.g., +V and ground (GND)) to and/or from the first device. Still other electrical contacts may be for providing and/or receiving control data signals to and/or from the first device.

As an example, if the data communication cable assembly 100 is configured in accordance with High-Definition Multimedia Interface (HDMI) protocol, the multimedia data electrical contacts may be pins 1-12 for receiving Transition Minimized Differential Signaling (TMDS) data signals, data shields, clocks, and clock shields from the first device as an HDMI source. The power contacts may be pins 17 and 18 for providing and/or receiving ground and +5V to and/or from the HDMI source. The control data may be pins 13-16 and 19 for providing and/or receiving Consumer Electronics Control (CEC) data, optional HDMI Ethernet channel or Audio Return Channel, Display Data Channel (DDC) clock (SCL), DDC data (SDA), and Hot Plug Detect with optical HDMI Ethernet Channel and Audio Return Channel to and/or from the HDMI source, respectively.

As another example, if the data communication cable 100 is configured in accordance with DisplayPort protocol, the multimedia data electrical contacts may be pins 1-12 for receiving multimedia channel data signals (positive, negative, and grounds) from the first device as a DisplayPort source. The power contacts may be pins 19 and 20 for providing and/or receiving power return and +3.3V to and from the DisplayPort source. The control data may be pins 15-18 for receiving and/or providing Auxiliary (AUX) channel related control signaling, (data positive/negative and ground) and Hot Plug Detect to and/or from the DisplayPort source, respectively.

The above HDMI and DisplayPort compliant cables are merely a couple of examples, but it shall be understood that the fire-retardant techniques described herein may be applied to other data communication cables, including Digital Visual Interface (DVI) cable, Universal Serial Bus (USB) cable, and Quad Small Form-factor Pluggable (QSFP) cable. The multimedia and control data are merely examples; and may alternatively be or include other types of data.

The first connector 110 may include electrical-to-optical (E2O) and/or optical-to-electrical (O2E) signal processing circuitry 112 for converting the multimedia data electrical signal into multimedia data optical signal and/or multimedia data optical signal into multimedia data electrical signal. In other words, the data communication cable assembly 100 may be configured for unidirectional optical signal transmission or bidirectional optical signal transmission.

With regard to E2O signal processing, such circuitry 112 may include one or more drivers for conditioning the multimedia electrical data signal received from the first device for driving one or more lasers, and the one or more lasers for generating the multimedia data optical signals. The E2O signal processing circuitry 112 may further include one or more multiplexers for multiplexing two or more of the multimedia data electrical signal to generate a multiplexed data electrical signal for driving each laser.

With regard to O2E signal processing, such circuitry may include one or more photodiodes for converting the multimedia optical data signal into multimedia data electrical signal, and one or more signal conditioning circuits for conditioning the multimedia data electrical signal for compliant reception by the first device. The O2E circuitry 112 may further include one or more demultiplexers for demultiplexing each multiplexed multimedia data electrical signal into separate multimedia data electrical signals.

Additionally, the first connector 110 may include electrical signal processing circuitry 114 for performing signal processing on the control data electrical signal provided to and/or received from the first device. Such circuitry 114 may include signal conditioning for compensating the control data electrical signal received via the cable 130 for adverse effects (e.g., distortion) caused by transmission via the wire communication medium of the cable 130 prior to providing the control data electrical signal to the first device. Such signal conditioning may include amplifying, buffering and/or equalizing the control data electrical signal.

The circuitry 114 may also include signal conditioning for compensating the control data signal received from the first device for adverse effects (e.g., distortion) to be caused by transmission via the wire communication medium of the cable 130 prior to sending the control data electrical signal across the cable 130 to the second connector 120. Such signal conditioning may include amplifying and/or pre-emphasizing (e.g., modifying or sharpening the data transitions of) the control data signal.

The E2O and/or O2E signal processing circuitry 112 and the electrical signal processing circuitry 114 may be formed at least partially on a printed circuit board (PCB) 116. As depicted, the PCB 116 may include a signal ground pad and related traces as represented by the illustrated ground pad. Additionally, the housing or shell of the connector 110 may be connected to chassis ground.

The second connector 120 includes electrical contacts (e.g., pins and/or sockets) for electrically mating with corresponding electrical contacts (e.g., sockets and/or pins) of the second device. Some of the electrical contacts may be for providing and/or receiving multimedia data (e.g., video and/or audio data) signals to and/or from the second device. Other electrical contacts may be for providing and/or receiving power signals (e.g., +V and ground (GND)) to and/or from the second device. Still other electrical contacts may be for providing and/or receiving control data signals to and/or from the second device.

The second connector 120 may be compliant with any of a number of protocols, as discussed with reference to the first connector 110. That is, the second connector 120 may be compliant with HDMI, DisplayPort, DVI, QSFP, USB, and others.

The second connector 120 may include 02E and/or E2O signal processing circuitry 122 for converting multimedia data optical signal into multimedia data electrical signal and/or multimedia data electrical signal into multimedia data optical signal.

With regard to O2E signal processing, such circuitry 122 may include one or more photodiodes for converting the multimedia optical data signal into multimedia data electrical signal, and one or more signal conditioning circuits for conditioning the multimedia data electrical signal for compliant reception by the second device. The O2E signal processing circuitry 122 may further include one or more demultiplexers for demultiplexing each multiplexed multimedia data electrical signal into separate multimedia data electrical signals.

With regard to E2O signal processing, such circuitry 122 may include one or more drivers for conditioning the multimedia electrical data signal received from the second device for driving one or more lasers, and the one or more lasers for generating the multimedia data optical signals. The E2O signal processing circuitry 122 may further include one or more multiplexers for multiplexing two or more of the multimedia data electrical signal to generate a multiplexed data electrical signal for driving each laser.

Additionally, the second connector 120 may include electrical signal processing circuitry 124 for performing signal processing on the control data electrical signal provided to and/or received from the second device. Such circuitry 124 may include signal conditioning for compensating the control data electrical signal received via the cable 130 for adverse effects (e.g., distortion) caused by transmission via the wire communication medium of the cable 130 prior to providing the control data signal to the second device. Such signal conditioning may include amplifying, buffering and/or equalizing the control data electrical signal.

The circuitry 124 may also include signal conditioning for compensating the control data signal received from the second device for adverse effects (e.g., distortion) to be caused by transmission via the wire communication medium of the cable 130 prior to sending the control data signal across the cable 130 to the first connector 110. Such signal conditioning may include amplifying and/or pre-emphasizing (e.g., modifying or sharpening the data transitions of) the control data electrical signal.

The O2E and/or E2O signal processing circuitry 122 and the electrical signal processing circuitry 124 may be formed on a PCB 126. As depicted, the PCB 126 may include a signal ground pad and related traces as represented by the illustrated ground pad. Additionally, the housing or shell of the connector 120 may be connected to chassis ground.

The cable 130 includes a set of one or more optical fibers 140 for transmitting the multimedia data optical signals from the first connector 110 to the second connector 120, or in both directions. Additionally, the cable 130 further includes a set of one or more electrical wires (e.g., copper wires) for transmitting control data and/or power signals from the first connector 110 to the second connector 120, from the second connector 120 to the first connector 110, or in both directions. The set of one or more electrical wires may include twisted pair of wires, which may be present in the case that the data communication cable assembly 100 is compliant with USB 3.0/3.1.

To effectuate the electromagnetic shielding, the cable 130 further includes an inner electrically-conductive foil or sheet 136 (e.g., an aluminum-mylar sheet) coaxially surrounding at least the one or more wire communication mediums 150 and optionally the one or more optical fibers 140 throughout substantially the entire length of the cable 130. Because the wire communication mediums 150 emit electromagnetic energy, the electrically-conductive foil or sheet 136, being coaxially surrounding the wires, prevents or reduces electromagnetic leakage out of the cable 130.

To provide additional electromagnetic shielding, the cable 130 further includes an outer electrically-conductive braid 134 (e.g., a copper braid) coaxially surrounding the inner electrically-conductive foil or sheet 136 throughout substantially the entire length of the cable 130. Further, the cable 130 may optionally include an electrical-conductor (referred to herein as a “drain”) that is electrically coupled to the electromagnetic shielding layers 134 and 136, and extending throughout the length of the cable 130 with opposite ends electrically attached to chassis and/or signal ground at connectors 110 and 120, respectively. That is, at each connector, the drain may be: (1) attached to the connector housing for chassis grounding, (2) attached to the ground pad on the PCB for signal grounding, or (3) attached to the connector housing or the PCB ground pad, and the connector housing being electrically connected to the ground pad on the PCB, for both chassis and signal grounding. The grounding of the electromagnetic shielding layers 134 and 136 via the drain wire 138 and the ground pads of the PCBs 116 and 126 improves the electromagnetic shielding of the electrically-conductive shielding layers 134 and 136.

With further reference to FIG. 1B, which illustrates a cross-section of the cable 130 along line B-B, to effectuate fire-retardant for the cable 130, the cable assembly 100 includes an outer coaxial jacket 132 made out of fire-retardant material (e.g., FEP) coaxially enclosing the optical communication medium 140, the wire communication medium 150, the metal (e.g., copper braid) 134, the metal (e.g., aluminum) foil 136, drain wire 138, and one or more aramid fibers 160 for substantially the entire length of the cable 130. The aramid fibers 160 occupies space within the cable 130 to reduce movement of the other components within the cable and improve the strength of the cable.

Additionally, the cable assembly 100 includes a tube 142 made out of fire-retardant material (e.g., Ethylene Tetrafluoroethylene (ETFE) or polyolefin) coaxially enclosing the one or more optical communication mediums 140 and one or more aramid fibers 160 for substantially the entire length of the cable 130. Similarly, the aramid fibers 160 occupies space within the tube 142 to reduce movement of the optical communication medium within the tube and improve the strength of the cable.

Further, the cable assembly 100 includes a coating 152 made out of fire-retardant material (e.g., FEP) coaxially disposed over each wire communication medium 150 for substantially the entire length of the cable 130. The coating 152 also serves as an electrically-insulating layer to prevent the various wires 150 from electrically contacting each other inside the cable 130.

The following combination makes the cable 130 compliant with the current NFPA, CPR, and the IEC: the fire-retardant (e.g., FEP) jacket 132 coaxially enclosing all the contents of the cable 130 for substantially the entire length of the cable; the tube 142 (e.g., Ethylene Tetrafluoroethylene (ETFE) or polyolefin) coaxially enclosing the one or more optical communication mediums 140 (e.g., optical fibers) and one or more aramid fibers 160 for substantially the entire length of the cable 130; and the fire-retardant coating 142 (e.g., FEP) coaxially disposed over each of the one or more wire for substantially the entire length of the cable 130. The cable 130 is environmentally-safe because it may not include PVC.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

1. A data communication cable assembly, comprising:
a cable including a set of one or more communication mediums for transmitting one or more data signals, one or more control signals, and/or one or more power signals;
a first connector, attached to a first end of the cable, configured to mate with a corresponding connector of a first device, wherein the first connector includes a first set of electrical contacts configured to send and/or receive the one or more data signals, the one or more control signals, and/or the one or more power signals to and/or from the first device;
a second connector, attached to a second end of the cable, configured to mate with a corresponding connector of a second device, wherein the second connector includes a second set of electrical contacts configured to send and/or receive the one or more data signals, the one or more control signals, and/or the one or more power signals to and/or from the second device;
a jacket made out of a fire-retardant material coaxially enclosing the one or more communication mediums for substantially an entire length of the cable;
a first electrical conductor coaxially surrounding the set of one or more communications mediums for substantially the entire length of the cable; and
a second electrical conductor coaxially surrounding the first electrical conductor for substantially the entire length of the cable.

2. The data communication cable assembly of claim 1, wherein the fire-retardant material comprises Flourinated Ethylene Propylene (FEP).

3. The data communication cable assembly of claim 1, wherein the one or more communication mediums comprises one or more optical fibers, respectively, and further comprising a tube made out of fire-retardant material coaxially enclosing the one or more optical fibers for substantially the entire length of the cable, wherein the jacket coaxially encloses the tube for substantially the entire length of the cable.

4. The data communication cable assembly of claim 3, wherein the tube comprises Ethylene Tetrafluoroethylene (ETFE) or polyolefin.

5. The data communication cable assembly of claim 3, further comprising one or more aramid fibers extending longitudinally for substantially the entire length of the cable within the tube.

6. The data communication cable assembly of claim 1, wherein the one or more communication mediums comprises one or more wire communication mediums, respectively, wherein each of the one or more wire communication mediums is coated with a fire-retardant material for substantially the entire length of the cable.

7. The data communication cable assembly of claim 6, wherein the fire-retardant material coated over each of the one or more wire communication mediums comprises Flourinated Ethylene Propylene (FEP).

8. The data communication cable assembly of claim 6, further comprising one or more aramid fibers extending longitudinally for substantially the entire length of the cable within the jacket.

9. A data communication cable assembly, comprising:
a cable comprising:
one or more optical communication mediums for transmitting a first set of one or more data signals;
one or more wire communication mediums for transmitting a second set of one or more control signals and/or one or more power signals;
a first electrical conductor coaxially surrounding the set of one or more wire communications mediums for substantially the entire length of the cable; and
a second electrical conductor coaxially surrounding the first electrical conductor for substantially the entire length of the cable;
a first connector, attached to a first end of the cable, configured to mate with a corresponding connector of a first device, wherein the first connector includes a first set of electrical contacts configured to send and/or receive the one or more data signals, the one or more control signals, and/or the one or more power signals to and/or from the first device;
a second connector, attached to a second end of the cable, configured to mate with a corresponding connector of a second device, wherein the second connector includes a second set of electrical contacts configured to send and/or receive the one or more data signals, the one or more control signals, and/or the one or more power signals to and/or from the second device; and
a jacket made out of a fire-retardant material coaxially enclosing the first and second sets of wire and optical communication mediums for substantially an entire length of the cable.

10. The data communication cable assembly of claim 9, wherein the fire-retardant material comprises Flourinated Ethylene Propylene (FEP).

11. The data communication cable assembly of claim 9, further comprising a tube made out of fire-retardant material coaxially enclosing the one or more optical communication mediums for substantially the entire length of the cable, wherein the jacket coaxially encloses the tube for substantially the entire length of the cable.

12. The data communication cable assembly of claim 11, wherein the tube comprises Ethylene Tetrafluoroethylene (ETFE) or polyolefin.

13. The data communication cable assembly of claim 11, further comprising one or more aramid fibers extending longitudinally for substantially the entire length of the cable within the tube.

14. The data communication cable assembly of claim 9, wherein each of the one or more wire communication mediums is coated with a fire-retardant material for substantially the entire length of the cable.

15. The data communication cable assembly of claim 14, wherein the fire-retardant material coating comprises Flourinated Ethylene Propylene (FEP).

16. A data communication cable assembly, comprising:
a cable comprising:
one or more optical communication mediums for transmitting a first set of one or more data signals;
one or more wire communication mediums for transmitting a second set of one or more data signals and/or one or more power signals, wherein each of the one or more wire communication mediums is coated with a fire-retardant material for substantially the entire length of the cable;
a jacket made out of a fire-retardant material coaxially enclosing the optical and wire communication mediums for substantially an entire length of the cable;
a tube made out of fire-retardant material coaxially enclosing the one or more optical communication mediums for substantially the entire length of the cable, wherein the jacket coaxially encloses the tube for substantially the entire length of the cable;
a first electrical conductor coaxially surrounding the set of one or more wire and optical communications mediums for substantially the entire length of the cable; and
a second electrical conductor coaxially surrounding the first electrical conductor for substantially the entire length of the cable;
a first connector, attached to a first end of the cable, configured to mate with a corresponding connector of a first device, wherein the first connector includes a first set of electrical contacts configured to send and/or receive the one or more data signals, the one or more control signals, and/or the one or more power signals to and/or from the first device; and
a second connector, attached to a second end of the cable, configured to mate with a corresponding connector of a second device, wherein the second connector includes a second set of electrical contacts configured to send and/or receive the one or more data signals, the one or more control signals, and/or the one or more power signals to and/or from the second device.

17. The data communication cable of claim 16, wherein the fire-retardant material coated over the one or more wire communication mediums comprises Flourinated Ethylene Propylene (FEP).

18. The data communication cable of claim 16, wherein the fire-retardant material of the tube comprises Ethylene Tetrafluoroethylene (ETFE) or polyolefin.

19. The data communication cable of claim 16, wherein the fire-retardant material of the jacket comprises Flourinated Ethylene Propylene (FEP).

20. The data communication cable of claim 16, further comprising:
a first set of one or more aramid fibers extending longitudinally for substantially the entire length of the cable within the tube; and
a second set of one or more aramid fibers extending longitudinally for substantially the entire length of the cable within the jacket but outside of the tube.

21. The data communication cable of claim 1, wherein the first electrical conductor comprises an electrically-conductive foil or sheet.

22. The data communication cable of claim 21, wherein the second electrical conductor comprises an electrically-conductive braid.

23. The data communication cable of claim 1, further comprising a drain wire electrically coupled to the first and second electrical conductors.

24. The data communication cable 23, wherein the drain wire includes opposite ends attached to signal or chassis ground at the first and second connectors, respectively.

25. The data communication cable 1, wherein the jacket is an outer-most layer of the cable, and wherein the jacket comprises Flourinated Ethylene Propylene (FEP).
